(19) United States
(12) Patent Application Publication
(10) Pub. No.: US 2007/0248714 A1
(43) Pub. Date: Oct. 25, 2007

(54) HIGHLY-EFFICIENT OPTICAL COLLECTION AND REFLECTION SURFACE(S) AND MOLDING SYSTEM FOR MANUFACTURE OF SAME

(76) Inventors: David Dean, Commerce Twp., MI (US); Fred Yacobelli, Highland, MI (US)

Correspondence Address: DORT PATENT, P.C., Box 26219, Crystal City Station, Arlington, VA, 22215, US

(21) Appl. No.: 11/682,541

(22) Filed: Mar. 6, 2007

Related U.S. Application Data
(63) Continuation-in-part of application No. 10/978,829, filed on Oct. 29, 2004, now Pat. No. 7,186,006.
(63) Continuation-in-part of application No. 11/675,252, filed on Feb. 15, 2007.
Application No. 11/675,252 is a continuation of application No. 10/978,829, filed on Oct. 29, 2004, now Pat. No. 7,186,006.
(60) Provisional application No. 60/522,525, filed on Oct. 8, 2004.

(51) Int. Cl. B29C 45/03

(52) U.S. Cl. 425/542

(57) ABSTRACT

An improved optical collection and transmission surface includes a plastic mold injection surface including staggered multiple transmission sites each with a recessed portion in which incident light is not lost during reflection towards the propagation surface. A device implementing the surfaces is plastic-mold injected of high quality acrylic at in a preferred embodiment and can be economically optionally polished or finished to achieve desired quality surfaces.

### REFERENCE TO PRIORITY DOCUMENTS

This application is a continuation-in-part and claims priority under 35 USC §120 to U.S. provisional application Ser. No. 10/978,829, filed Oct. 29, 2004, now U.S. Pat. No. 7,186,006 issued Mar. 6, 2007. This application is also a continuation-in-part, claim priority under 35 USC §120 to U.S. application Ser. No. 11/675,252, filed Feb. 15, 2007, which is a continuation claiming priority to U.S. application Ser. No. 10/978,829, filed Oct. 29, 2004. U.S. patent application Ser. No. 10/978,829 claims priority to U.S. Provisional Application Ser. No. 60/522,525, filed Oct. 8, 2004. All of these above-referenced applications are incorporated by reference for all purposes.

### BACKGROUND

U.S. Pat. No. 6,422,713, incorporated by reference for all purposes, and currently owned by Ford Global Technologies, and illustrated by FIGS. 1A and 1B shown that a collimator lens is used in conjunction with a laser diode for automotive illumination purposes. The problem with this collimator lens is two-fold: first, the current teaching means that the incident light transmitted by the reflecting surface is lost in the illustrated zones where the lens turns to creating the reflecting angle (45 degrees as illustrated), reducing the efficiency of light collection. This is illustrated in FIG. 1C. Furthermore, in order to create an efficient transmission, the lens must be “polished” in order to create an efficient transmission lens. This polishing can partially destroy the surface of the lens, which means that the lens becomes unusable, or a reduced amount of polishing can occur. Either problem results in higher cost and/or reduced efficiency.

### BRIEF DESCRIPTION OF THE DRAWINGS

FIGS. 1A and 1B illustrate the prior art collimator lens;

FIG. 1C illustrates the problem of the loss of transmitted radiation (light) in the prior art;

FIG. 2 illustrates a cutaway view of a sample transmission surface in a first embodiment of the invention;

FIG. 3 illustrates a rear view of the transmission surface;

FIG. 4 illustrates the improved radiation transmission at a single radiation source

FIG. 5 illustrates the cumulative effect of multiple improved transmission points;

FIG. 6 illustrates a plastic mold for making the improved surface in a plastic mold injection embodiment of the invention;

FIG. 7A shows a model of a first embodiment of the improved collimator from a ¾ view;

FIG. 7B shows a front view of the first embodiment of the improved collimator;

FIG. 7C shows an ¼ view of the first embodiment of the improved collimator;

FIG. 7D shows a side view of a first embodiment of the improved collimator;

FIG. 8A shows a finished surface in a economical plastic-mold injection system;

FIG. 8B illustrates a polishing step in which the improved surface is not degraded and keeps the desirable optical transmission properties; and

FIG. 9 shows a second embodiment of the invention, in the form of a reduced-material model of the invention;

FIG. 10 is a functional diagram of the second embodiment of the invention with the optical collection and transmission surfaces;

FIG. 11 is a second functional diagram of the second embodiment in which the collection surface is “staggered” vertically;

FIG. 12A illustrates the front surface of the second embodiment of invention;

FIG. 12B illustrates the rear surface of the second embodiment of the invention.

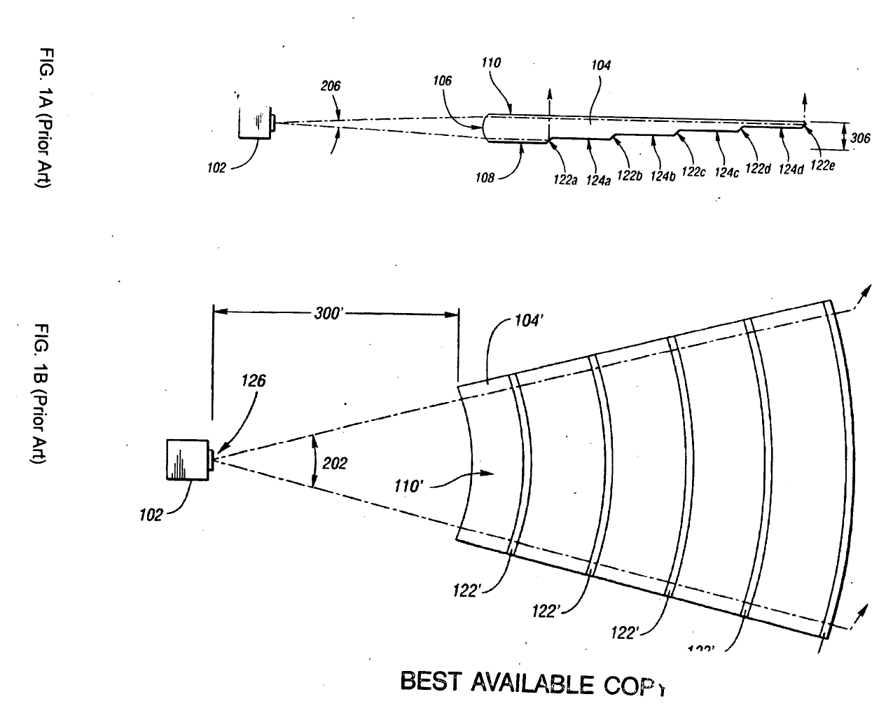

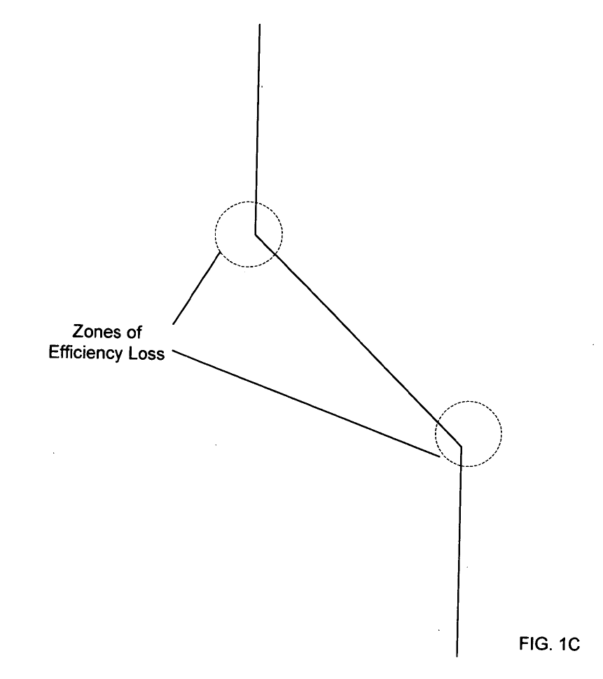

### DETAILED DESCRIPTION

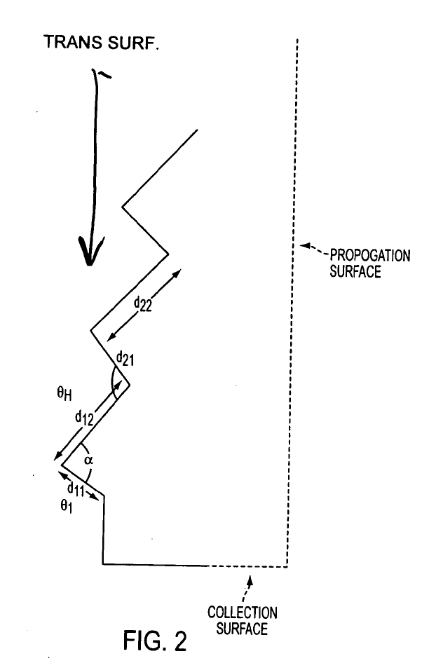

FIG. 2 illustrates a sample of the invention in a first embodiment in which the cutaway view of the improved collimation system is shown. Light or other types of radiation (coherent or divergent) is “collected” at the collection surface (marked) and passed through a series of reflection/transmission areas which comprise the transmission surface (marked) and passes out the projection surface (marked).

The transmission surface includes a series of transmission areas each of which include a protrusion section (shown as d11) at angle Θ1 out from the direction of the radiation which then turns “inward” (towards the projection surface) at angle ω1 and a reflection surface d12, which protrudes into the interior, past the point (p(i1)) at which (in the y-direction) d11 started to move “outward.”

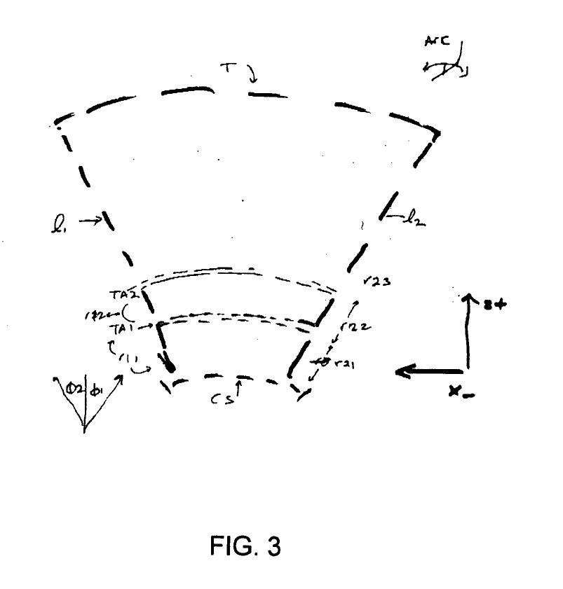

The inventive transmission surface TS may be implemented in a number of ways depending on the intended end use of the device. However, a first embodiment, as shown in FIGS. 2 and 3, is a collimation lens (collimator) for illumination use. Therefore, additional transmission areas are configured along the transmission surface moving in the y+ direction towards the “top” T of the collimator. The transmission areas are marked as a combination of the two (or more in alternate embodiments) “sides” (d21)+(d22) and angles Θ2, ω2, increasing by index number in the z+ or “upward” direction (e.g. d31, d32, Θ3, ω3, etc.). As can be appreciated by those skilled in the art, the transmission surface does not need to be entirely comprised of transmission areas, but can be configured to maximize transmission to the propagation surface PS as shown in the drawings.

FIG. 3 is a “front” view of the transmission surface TS. Successive transmission areas ta1, ta2, . . . , are shown running in an horizontal arc (in the x± direction, which also rise and fall in the z± direction as well) along the length (L1 and L2) of the collimator lens to the top T which also may be configured in an arc. The angles respectively formed by each side (L1, L2) and the z-axis are shown by angles Φ1 in the x+ direction and Φ2 in the x-direction. In the shown embodiment, the two angles and sides are respectively the same, but do not need to be. The distance between each transmission zone ta1, ta2, . . . is shown as r11, r12, . . . along side I1 and r21, r22, . . . along side I2. The collection surface CS is discussed in U.S. Pat. No. 6,422,713, which is incorporated by reference and will not be discussed further for the sake of economy.

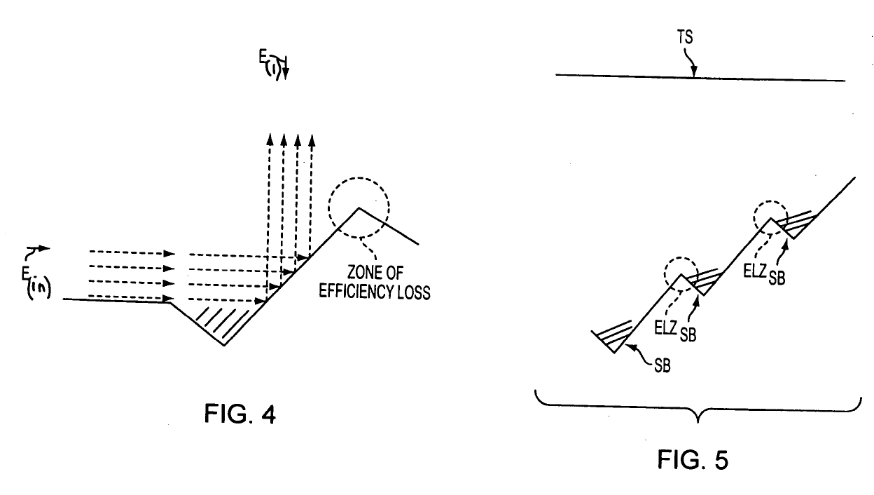

Referring now to FIG. 4, a diagram of the electromagnetic energy transmission in the improved lens is shown. Electromagnetic energy, generally in the form of infrared light and shown by the dashed arrows and marked as the Electromagnetic radiation field E⁻(init), moves along the z-axis in the positive direction. In most embodiments, the (incident) light will enter the collimator at the collection surface CS, discussed above and be reflected towards the propagation surface (see FIG. 2). Although the light energy in E⁻(init) will be lost at the single zone of efficiency loss (marked), and have the energy now in the transmitted E⁻(1) field, the recessed portion SB will prevent the light energy from loss at more than one transition point per transition area (see FIGS. 2 and 3). Efficiency loss in these zones is generally due to several factors, some from optical transmission limits, but generally, some efficiency loss is related to limitations in the manufacturing and finishing process(es) of materials are economical enough to make the end-use device economically practical.

The improved transmission surface is apparent in FIG. 5 in which we see how many zones of efficiency loss ELZ are eliminated along multiple transmission areas and replaced with the recessed portions SB which also protect the transmission surface TS, during the manufacturing and finishing process (see below.)

Although a primary embodiment of the invention is for manufacturing “collimation devices” for use in illuminations systems, it is contemplated that the improvements to the energy transmission surface(s) and reduced cost of manufacturing will also provide valuable in the manufacturing of other systems needing optical or electromagnetic collection and transmission in the manner (e.g. energy source point or divergent spread to planar or “spacial” spread).

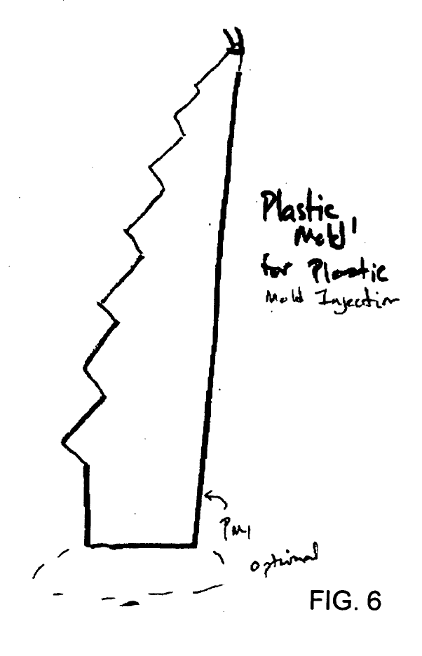

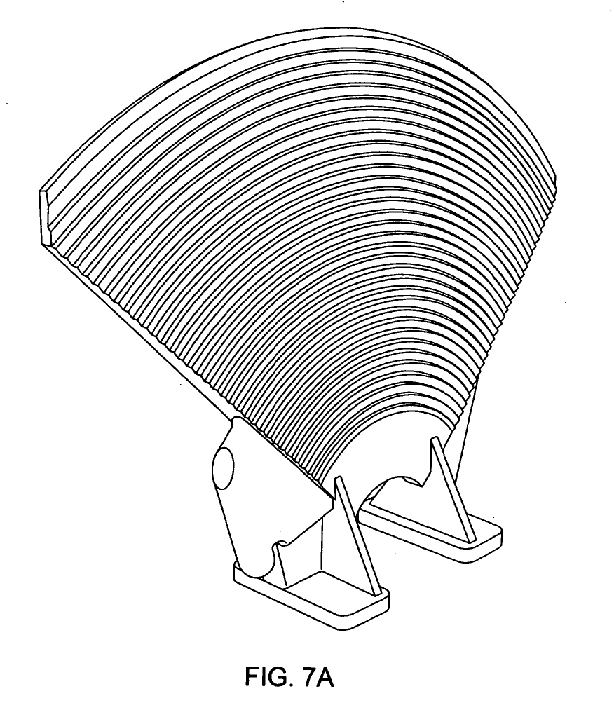

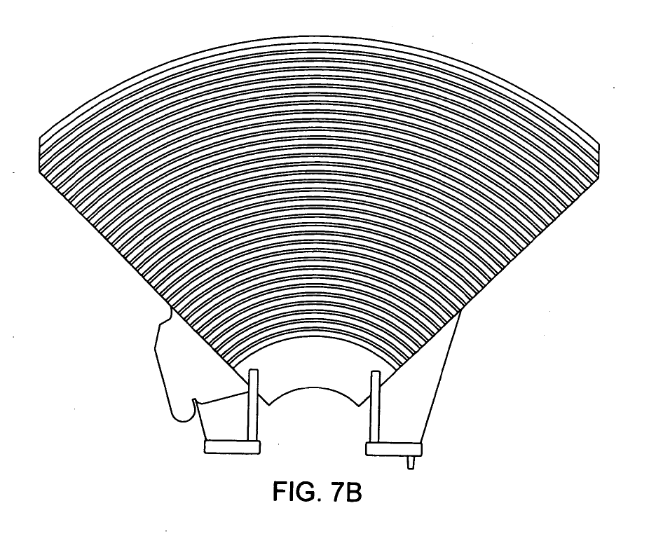

Referring now to FIG. 6, a preferred embodiment of the invention is shown as a mold for a plastic mold injection of devices that implements the improved collection and transmission surface of the present invention. In particular, the plastic mold injection with the extended angle and protrusion (Θ1, Θ2, . . . ) serves to protect the efficiency of the transmission surface during polishing. This improvement allows for two distinct advantages of the present invention over the existing art. First, devices implementing the enhanced transmission surface allow for the implementation of an easier plastic mold injection process. Secondly, the polishing or finishing of the end-use collimators or other devices can be implemented more cheaply and include a more thorough polishing method due to the durable surface. Even in the event of over polishing, the loss of a plastic molded collimator with the improved transmission surface will be on the order of a few dollars due to the inexpensive materials and manufacturing techniques. These are discussed below as well as illustrated by the Appendix A.

The materials used for the manufacture of the present invention are generally inexpensive clear polymers, which is generally acrylic, but may vary depending on the intended end use of the device implementing the improved transmission surface. Discussion of the choice and implementation of the appropriate materials for the present invention is included in the series Speaking of Plastics Manufacturing by Bill Fry and published by the Society of Manufacturing Engineers (1999), which are incorporated by reference herein, specially the titles: “Working with Acrylic,” “Working with Vinyl,” and “Working with Polyethylene.” Also useful for choosing and implementing the appropriate materials and specific plastic injection mold manufacturing techniques is the Handbook of Plastics, Elastomers and Composites, 4^{th} ed., by Charles A. Harper (McGraw-Hill 2002), which is also incorporated by reference herein.

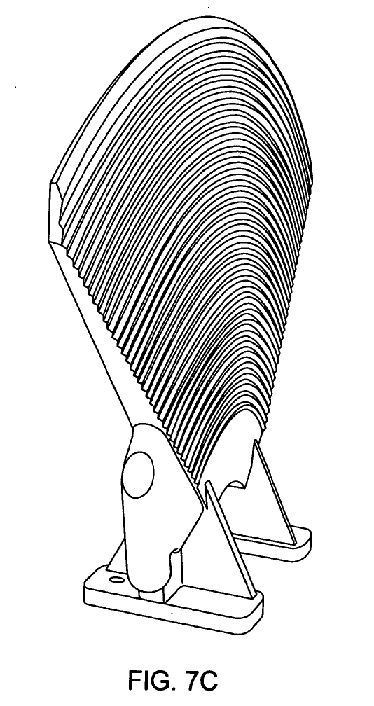

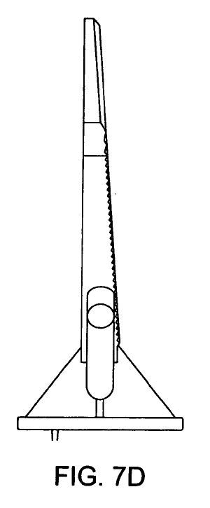

Referring now to FIG. 7A, a first embodiment of a compound component plastic-mold injected collimator is shown from a ¾ front-to-side angle. A two piece system is illustrated in which the lens LS is manufactured apart from the installation apparatus IA, which may be thermally or chemically welded on-site or at other locations. FIG. 7B shows a front view of the first embodiment of the improved collimator; FIG. 7C shows an ¼ view of the first embodiment of the improved collimator; and FIG. 7D shows a side view of a first embodiment of the improved collimator. In alternate embodiments, any installation apparatus may be directly incorporated into the mold-injection system or made out of a different material, if necessary at all.

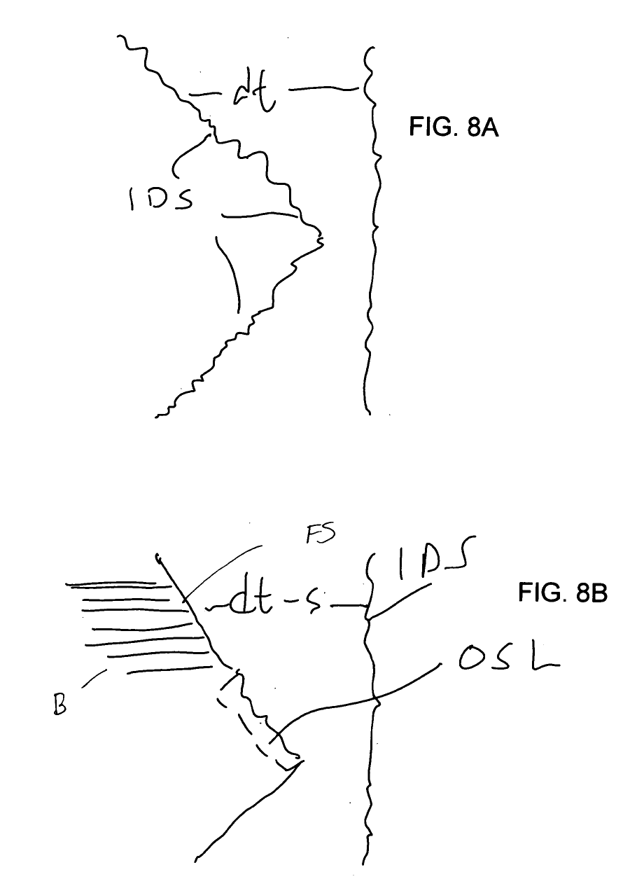

FIGS. 8A and 8B further illustrate the advantages of particular embodiments of the present invention in the manufacturing process. The inexpensively plastic-molded acrylic lens may have (enhanced for effect) imperfect surface defects IDs which prevent the efficient transmission of light through the collimator. An inexpensive buffering or finishing process (shown below) can be done by machine in a manner that may erode the transmission surface TS. The “unfinished” thickness of the transmission surface is shown as thickness dt, which, of course, will vary from point to point.

FIG. 8B shows that by using the present plastic-mold system for the improved collimation, the transmission surface may be partially eroded by the machine buffering or brushing (shown as B) processing to create a “finished surface” FS, which will transmit or reflect electromagnetic energy at a high efficiency rate, but not erode the transmission surface significantly. Alternately, inexpensive methods of machining that still provide for efficient transmission and a stable structure may be used. The finished thickness of the transmission surface is shown as thickness dt-p or the thickness shown in FIG. 8A minus the surface erosion from the polishing process. In particular embodiments, only those areas which are important for transmission can be polished or buffered. For example, an optional surface length OSL may be left unfinished if high optical transmission/reflection is not important for the particular length of the transmission surface. Similarly, the rear surface of the transmission surfaces may also not require the buffering process and can be left with the surface defects IDs. Although it is anticipated in a preferred embodiment that polishing all surfaces will be economical as optical transmission efficiency is vital.

In a first embodiment, the invention is a plastic mold for plastic mold injection. The plastic mold includes a hollow space for a clear polymer material including a first flat smooth surface and a second surface opposite the first surface. The second surface includes at least one irregular V-shaped surface connected to a vertical or nearly vertical surface at a first connection point. In this first connection point, a first linear portion of the V-shape moves away from the first surface at the connection at a first angle for a first distance. A second linear portion moves towards the first surface at a second angle for a second distance to a first transition point. In this way, such a transition point is closer to the first surface than the first connection point. The first angle is generally between 40 and 50 degrees from the vertical axis and is approximately 45 degrees from the vertical axis. The surface may include multiple irregular V-shaped surfaces connected at multiple transition points, and the first and second surfaces meet at a point and the second angles are between 40 and 50 degrees from the vertical axis. This first transition point is connected to a second vertical or nearly vertical portion. A second irregular V-shaped structure is connected to the second vertical portion at a second transition point. The plastic mold is configured to accept clear acrylic. In an alternate embodiment, multiples of the irregular V-shapes are connected to a successive transition point and configured such that the first and second surfaces meet at a point.

The plastic mold further includes an end-use connection configuration in volumetric contact with at least the first or the second surfaces. In a preferred embodiment, the connection is at least one cylindrical peg.

In the lens embodiment, a first collection surface is perpendicular to and connects the first and second surfaces. This first collection surface is a portion of a cylindrical shape.

APPENDIX A includes the material(s) used in a preferred and alternate embodiment of both the manufacturing system and the improved collimation system as well as materials regarding the manufacturing process The material is generally high-quality acrylic and may include other materials that are related to the desired properties. The material provided by ATOFINA® is shown in Appendix A and technical papers from ATOFINA® related to the acrylic shown in are hereby incorporated by reference.

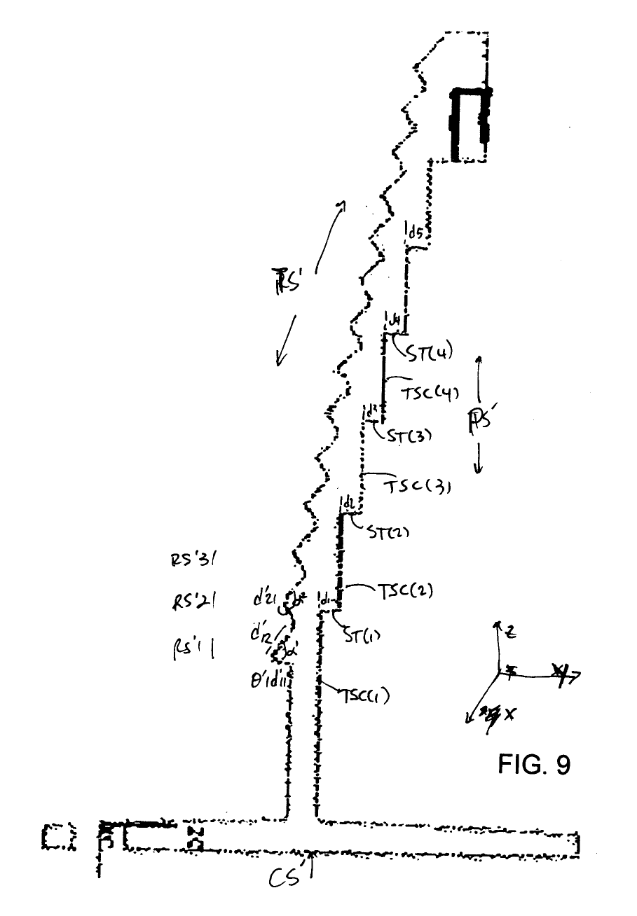

FIG. 9 illustrates a second or alternate embodiment of the inventive collimator, which requires even less high-quality acrylic material than the first embodiment. In the alternate embodiment, the propagation surface PS′ is cut in a staggered pattern, such that the light/electromagnetic energy will eventually emanate from different y-axis locations (back to front) along the Z-axis (bottom to top), which are shown as each propagation surfaces TSC(1), TSC(2) . . . TSC(n)(which is located at the top of the collimator). The distance between the “staggers” for the vertically-staggered propagation surfaces TSC(1), TSC(2) . . . TSC(n), is shown in the staggered collection surfaces ST(1), ST(2) . . . , ST(n) which are perpendicular to the staggered propagation surfaces along the y-axis, and is shown as distance d1, for the y axis distance from surface ST(1) to ST(2), d2 for the y-axis distance from surface ST(2) to ST(3), etc. Although the “stagger” distances d1, d2 . . . dn, are shown as similar, there is not any particular limitation that requires that the distances be uniform if the end use of the collimator requires a different configuration.

In the alternate embodiment, the transmission surface TS′ operates on much of the same principle as recited above for FIGS. 2, 4 and 5, includes a series of transmission areas or reflection surfaces RS′(1), RS′(2) . . . RS′(n), each of which include a protrusion section (shown as d′11) at angle Θ′1 “out” from the y-direction of the radiation which then turns “inward” (towards the propagation surface PS′) at angle ω′1 and a reflection surface d′12, which protrudes into the “interior” of the collimator where the electromagnetic energy is traveling in the z-direction.

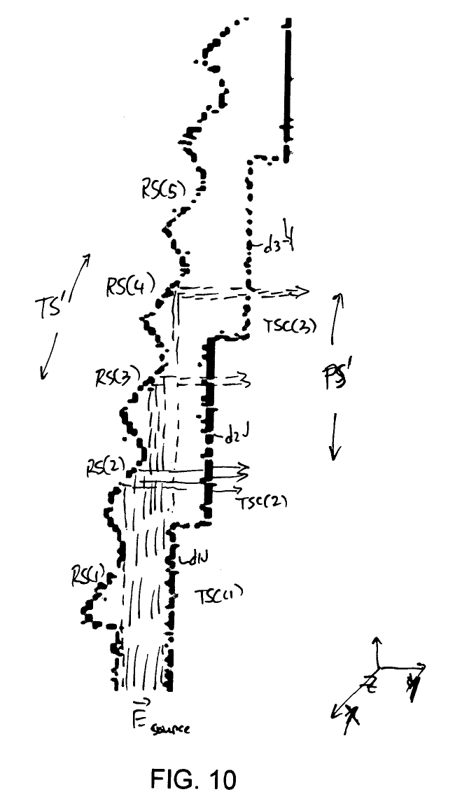

FIG. 10 illustrates the electromagnetic propagation principle involved in the alternate reduced-material embodiment shown in FIG. 9. The optical source travels “up” the z-axis in the optical collector through the clear acrylic to the reflection surfaces RS(1) . . . RS(n), that are positioned at angles similar to those detailed in the first embodiment described above, which allow the reflection surfaces RS(1) . . . RS(n) to be polished/brushed in an economical manner that does not degrade the reflection properties of the transmission surface S′ because of the improved configuration.

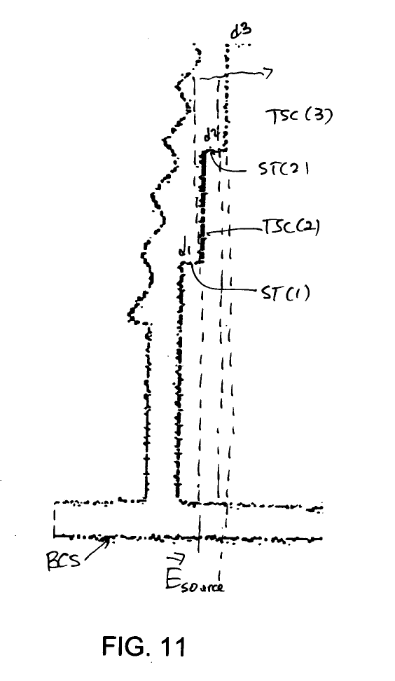

Referring now to FIG. 11, a second functional diagram of the second embodiment is shown. FIG. 11 should be understood as illustrating an additional advantage of the second embodiment of the invention, such that the staggered underside surfaces ST(1) . . . ST(n) to act as “collection surfaces,” because the electromagnetic energy E(source) passes though the base collection surface BCS, running parallel to the staggered propagation surface PS′ and entering the respective underside collection surfaces. Although a very small amount of electromagnetic energy may be lost because of the transmission efficiency of the high-quality acrylic, the optical energy is “entering” the secondary surfaces ST(1), ST(2) . . . ST(n), which perpendicular to the direction of the energy, and therefore the amount of lost energy lost is balanced out by the cost savings of high-quality material. Additionally, the reduced weight and footprint of the improved collimator also balances out the minor loss of energy that is lost by the light passing through two collection surfaces.

Additionally, it is possible for the secondary collection surfaces ST(1) . . . ST(n) to be placed at optimal angles, if the laser diode source requires it. Although the secondary collection surfaces ST(1) . . . ST(n) would have to be placed such that there is no energy loss from the angled transmission surfaces RS(1) . . . RS(n), in which the light is transmitted in any direction but forward.

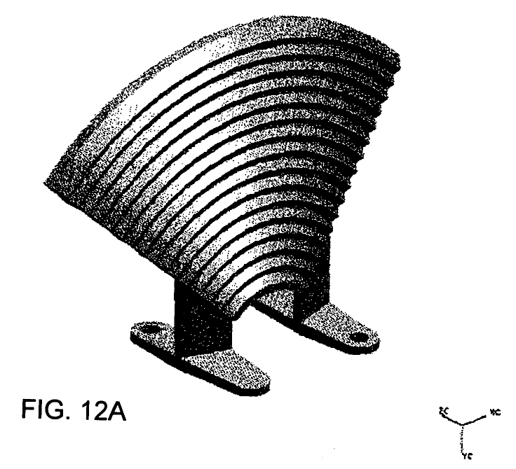

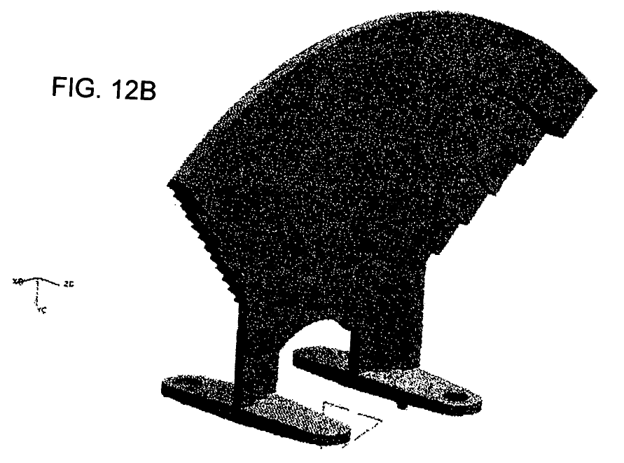

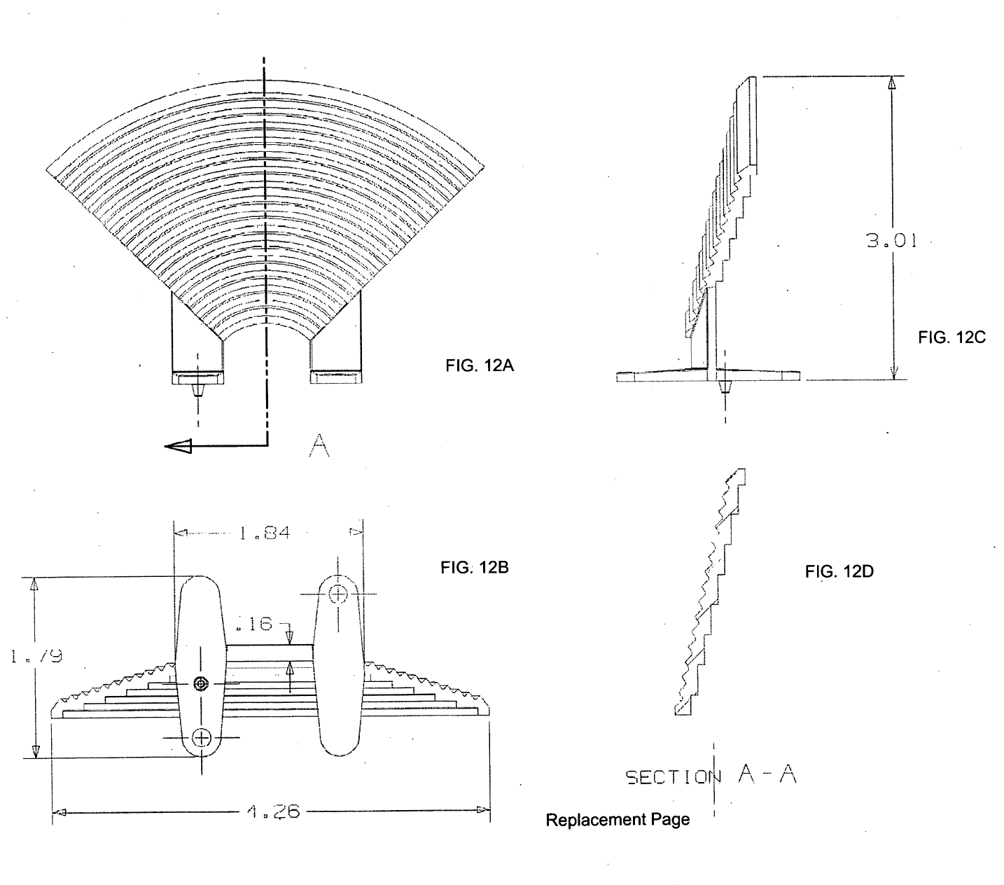

FIGS. 12A and 12B illustrate alternate views of the second embodiment of the invention from both the front and rear views respectively. Like the embodiments shown in FIGS. 7A-D, the collimator may be constructed in several ways depending on the needs of the end user. However, much of the construction for the second embodiment is shown in FIGS. 7A-D. The base portion may be molded with the collimator portion, but optimally is attached in an efficient manner, through a pin, or chemical or thermal welding. The base portion should be tailored to the end use of the collimator as it will determine the distance between the laser diode source and the collection surface CS′ or the angle at which the propagation surface PS′ direction the electromagnetic energy.

In the lens embodiment, the shape and design of the overall collimator may vary depending on the end-use applications, and the incorporation of the improved transmission surface into collimators is only part of the scope and spirit of the invention. The manufacturing improvements and enormous savings resulting from implementation of the improve surface(s) are also within the scope and spirit of the claims.

What is claimed is:

1. A plastic mold for plastic mold injection including: a hollow space for a clear polymer material, said hollow space including a first flat smooth surface and a second surface opposite said first surface, said second surface including at least one irregular V-shaped surface connected to a vertical or nearly vertical surface at a first connection point in which a first linear portion of said V-shape moves away from said first surface at said connection at a first angle for a first distance and a second linear portion which moves towards said first surface at a second angle for a second distance to a first transition point, such that said transition point is closer to said first surface than said first connection point.

2. The plastic mold as recited in claim 1, wherein said first angle is between 40 and 50 degrees from said vertical axis.

3. The plastic mold as recited in claim 2, wherein said first angle is approximately 45 degrees from said vertical axis.

4. The plastic mold as recited in claim 1, wherein said second surface includes multiple irregular V-shaped surfaces connected at multiple transition points.

5. The plastic mold as recited in claim 4, wherein said first and second surfaces meet at a point.

6. The plastic mold as recited in claim 4, wherein said second angles are between 40 and 50 degrees from said vertical axis.

7. The plastic mold as recited in claim 1, wherein said first transition point is connected to a second vertical or nearly vertical portion.

8. The plastic mold as recited in claim 8, wherein a second irregular V-shaped structure is connected to said second vertical portion at a second transition point.

9. The plastic mold as recited in claim 1, wherein a first collection surface is perpendicular to and connects said first and second surfaces.

10. The plastic mold as recited in claim 9, wherein said first collection surface is a portion of a cylindrical shape.

11. The plastic mold as recited in claim 1, configured to accept clear acrylic.

12. A plastic mold for plastic mold injection including: a hollow space for a clear polymer material, said hollow space including a first flat smooth surface and a second surface opposite said first surface, said second surface including at least one irregular V-shaped surface connected to a vertical or nearly vertical surface at a first connection point in which a first linear portion of said V-shape moves away from said first surface at said connection at a first angle for a first distance and a second linear portion which moves towards said first surface at a second angle for a second distance to a first transition point, such that said transition point is closer to said first surface than said first connection point, wherein multiple of said irregular V-shapes are connected to successive transition point and configured such that said first and second surfaces meet at a point.

13. The plastic mold as recited in claim 1, further including an end-use connection configuration in volumetric contact with at least said first or said second surfaces.

14. The plastic mold as recited in claim 13, wherein said connection is at least one cylindrical peg.

15. The plastic mold as recited in claim 13, wherein said mold is designed to be used with acrylic.

16. A plastic mold injection mold for use with a clear polymer: a first surface; a second surface relatively perpendicular to said first surface, that includes multiple zig-zags that consist of two uneven length sides wherein said first longer edge forms the portion of the zig-zag furthest away from said first surface, configured such that the angles formed by the longest edge of each of said zig-zags and the perpendicular to said first surface is between 125 and 145 degrees, rotating inward; and a smooth flat surface opposite said surface with zig-zags.

17. The mold as recited in claim 16, wherein said mold is configured for use with acrylic.

18. The mold as recited in claim 17, further including a hollow space for a mounting structure that is volumetrically in contact with said first edge.

19. The mold as recited in claim 17, wherein said mounting structure is configured to be in volumetric contact perpendicular to said second surface.

20. The mold as recited in claim 17, wherein said mounting structure is configured to be in volumetric contact perpendicular to said first surface.
